(19) United States
(12) Patent Application Publication
(10) Pub. No.: US 2021/0294687 A1
(43) Pub. Date: Sep. 23, 2021

(54) PRINTING DEVICE COMPONENT STATUS CLASSIFICATION

(71) Applicant: Hewlett-Packard Development Company, L.P., Spring, TX (US)

(72) Inventors: Fernando Friedrich, Porto Alegre (BR); Thays Silva, Jaboatao dos Guararapes (BR); Larissa Oliverira, Guelph (CA); Marlon Paula, Camaragibe (BR); Felipe Navarro, Recife (BR)

(73) Assignee: Hewlett-Packard Development Company, L.P., Spring, TX (US)

(21) Appl. No.: 17/262,403

(22) PCT Filed: Nov. 1, 2018
(86) PCT No.: PCT/US2018/058622

§ 371 Date: Jan. 22, 2021

(51) Int. Cl. G06F 11/07; G06F 11/34; G06N 20/00; H04N 1/00

(52) U.S. Cl. CPC G06F 11/0733; G06F 11/0751; G06F 11/0778; H04N 1/00074; G06N 20/00; H04N 1/00029; G06F 11/3476

(57) ABSTRACT

Example implementations relate to printing device component status classification. Some examples include a non-transitory machine-readable medium containing instructions executable by a processor to cause the processor to generate a plurality of statistical features corresponding to an event code associated with a particular component of a printing device using retrieved event log data of the printing device, classify a status of the particular component using a classifier resulting from a machine learning mechanism applied to the plurality of statistical features, and perform an action associated with the particular component based on the classified status.

### BACKGROUND

Printing devices, such as printers, copiers, etc., may be used to form markings on a physical medium, such as text, images, etc. In some examples, printing devices may form markings on the physical medium by performing a print job. A print job can include forming markings such as text and/or images by transferring print materials to the physical medium.

### BRIEF DESCRIPTION OF THE DRAWINGS

FIG. 1 illustrates a system for printing device component status classification according to an example;

FIG. 2 illustrates a diagram of a controller including a processor, a memory resource, and engines according to an example; and

FIG. 3 illustrates a method for printing device component status classification according to an example.

### DETAILED DESCRIPTION

Devices such as industrial presses and commercial printing devices have a plurality of components, both hardware and software, that make up the devices. These devices may experience downtime which can impact productivity and printing costs. Particular components of the device may cause the downtime, for instance because of failure of a particular component. In such an instance, maintenance may be a reactive process, such that a particular component is replaced after it is discovered to have failed and/or caused downtime of the device.

Some approaches to device and device component maintenance include replacing a particular component upon failure of the particular component or device after reviewing and diagnosing the issue that caused the failure. This can lead to unplanned downtime and unexpected costs due to a lack of pare parts, time conflicts with intervention scheduling, etc.

Other approaches include the use support vector machines and artificial neural networks to assess rolling bearings or diagnosing printing device issues by performing a series of parametric tests that do not use machine learning mechanisms. However, such approaches may only apply in specific situations and may be dependent on a particular device's system event logs infrastructure.

In contrast, examples of the present disclosure can be predictive such that a determination can be made as to whether a particular component of a device may be a candidate for replacement in a next intervention. The determination can be made using event logs of the device and machine learning mechanisms. For instance, examples of the present disclosure can use a targeted approach focused on a statistical analysis of device event logs to earlier diagnose, as compared to other approaches, whether a particular component of a device may fail in an intervention. In such examples, a recommendation can be made as to whether a particular component caused a failure of a device. That recommendation can be used by a technician, for instance, and the technician can bring an appropriate component to an intervention.

With examples of the present disclosure being predictive, print volume can be maintained, print quality can be improved, and user experience can be improved because printer downtime can be reduced as compared to other approaches, thus reducing user disruption. Examples of the present disclosure, for instance, can identify which particular component has failed and/or is a cause of a device failure (e.g., diagnose device failure origin) or is a likely cause of a device failure, which can reduce costs and improve post-sales consumer and/or user relationships.

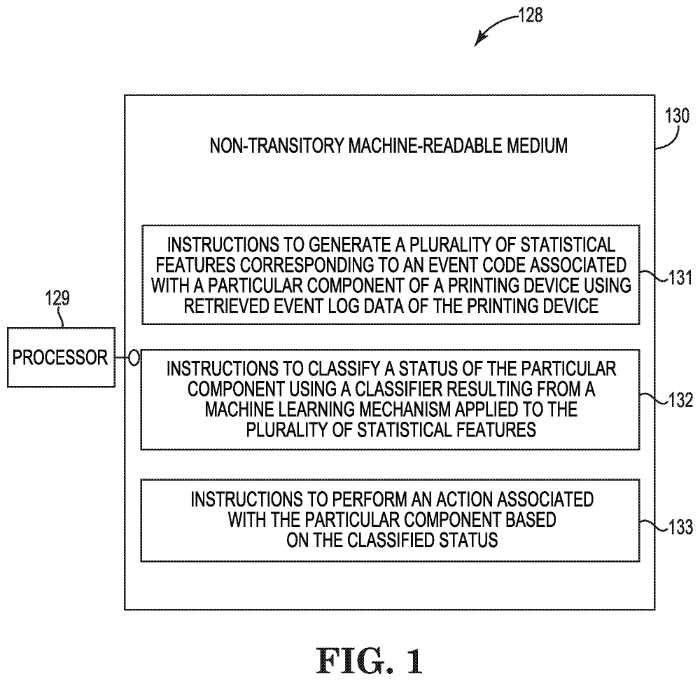

FIG. 1 illustrates a system 128 for printing device component status classification according to an example. As used herein, the term “printing device” refers to any hardware device with functionalities to physically produce representation(s) on the medium. In some examples, the printing device can be a laser printer, a scanning device, a laser printer/scanner combination device or other multifunctional printing device (e.g., A3 multifunctional printing device), among others. As used herein, the term “printing device component” refers to a hardware or software element associated with the printing device. While examples herein describe a printing device, the present disclosure is applicable to other devices such as industrial presses or other devices that may produce event logs and have particular components that may cause failure of the device.

System 128 can be a computing device in some examples and can include a processor 129. System 128 can further include a non-transitory machine-readable medium (MRM) 130, on which may be stored instructions, such as instructions 131, 132, and 133. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

Non-transitory MRM 130 may be electronic, magnetic, optical, or other physical storage device that stores executable instructions. Thus, non-transitory MRM 130 may be, for example, Random Access Memory (RAM), an Electrically-Erasable Programmable ROM (EEPROM), a storage drive, an optical disc, and the like on-transitory MRM 130 may be disposed within system 128, as shown in FIG. 1. In this example, the executable instructions 131, 132, and 133 can be “installed” on the device. Additionally and/or alternatively, non-transitory MRM 130 can be a portable, external or remote storage medium, for example, that allows system 128 to download the instructions 131, 132, and 133 from the portable/external/remote storage medium. In this situation, the executable instructions may be part of an “installation package”. As described herein, non-transitory MRM 130 can be encoded with executable instructions for vulnerability state report creation.

Instructions 131, when executed by a processor such as processor 129, can include instructions to generate a plurality of statistical features corresponding to an event code associated with a particular component of a printing device using retrieved event log data of the printing device. For instance, event log data from the printing device can be collected between a previous (e.g., a last) printing device intervention and the day that the printer failed. As used herein, an intervention includes a process of intervening with a printing device and/or its components. The intervention may be scheduled; for instance, a printing device may have periodic, scheduled maintenance. The intervention may be unscheduled, in some instances, such that it occurs responsive to an issue and/or failure of the printing device and/or a particular component. A particular component includes a component of the printing device including hardware (e.g., fuser, roller, scanner, etc.) or software.

The event codes can be used as a data set to generate the plurality of statistical features, and in some examples the event code includes a plurality of octets that represent a plurality of printing device components including the particular component and provide information related to each one of the plurality of components. The information can include, for instance, failure information, warnings, and information logs, among others. Examples include warnings related to cartridge shortage, errors in backup or firmware updates, malfunctions in a particular tray of the printing device, or information/alerts about proper performance of a print assignment, among others. In some examples, the event code includes a plurality of octets that represent an instruction received by the printing device and associated with a plurality of printing device components including the particular component that happened during a failure of the printing device.

From the retrieved event log data, statistical features can be generated using information about event codes and severity grouped by intervention. As used herein, severity refers to a gravity of the retrieved data including error information or warning information, among others. The event codes and associated data such as descriptive data provide information related to a status of printing device component or a feedback of a printing device instruction. Event codes can be related to a hardware component or a software component, and the event code can be formed of a plurality (e.g., three) octets representing the printing device component where a particular event happened or a software instruction that happened at a particular time. Each octet is a more detailed description of a previous octet. In some examples, because of this, reduced forms of the event codes can be used to create the statistical feature, combining the other information with the one-octet, two-octet, and full forms of code.

The statistical features can be generated by calculated values of grouped variables such as mean, mode, quantiles, variance, standard deviation, etc. By doing so, the event codes are translated into statistical values, describing life behavior of the printing device, which allows for detection of patterns of printing device component failures. For instance, for each event code, a series of a number of times the event code occurred in a particular time period (e.g., a day, a month, etc.) can be created.

Using the series (denoted “S”), a plurality of statistical features can be determined. For instance, S is the amount of times a code happened on each day between a previous intervention and a printing device failure. The statistical features can include, for instance, “has”, “sum”, “mean-bydate”, “var-bydate-biased”, “std-bydate-biased”, “mean-byserie”, “sem”, “var-byserie-biased”, “std-byserie-biased”, “var-byserie-unbiased”, “std-byserie-unbiased”, and “quantiles”, among others. Each event code has each one of the plurality of statistical features associated with it.

The “has” feature is yes or no feature such that it is determined whether S has the event code. The “sum” feature is a sum of the elements of S. The “mean-bydate” feature is the mean of the elements of S based on the number of days between the previous intervention and the printing device failure. For instance, if it took fifteen days for the printing device to fail (e.g., since the last intervention) and there are three elements in S (e.g., because the event code occurred three times in the fifteen days), the “mean-bydate” is the sum of the elements of S divided by the total number of days in S (e.g., fifteen in this example). Statistical features that are based on the number of days and a number of times per day the event code was present between the last intervention and the failure of the printing device regardless of whether the event code was present on each of the number of days are considered “biased”, Statistical features that are based on the number of days and a number of times per day the event code was present between the last intervention and the failure of the printing device are considered “unbiased”.

The “var-bydate-biased” feature is the variation of S based on the “mean-bydate” feature. The “std-bydate-biased” feature is the standard deviation of S based in the “var-bydate-biased” feature. The “mean-byserie” feature is the mean of the series S that does not consider days the event code doesn't happen. For the example above, the “mean-byserie” considers three days. This differs from “mean-bydate” which can have gaps in the sequence (e,g., because it considers fifteen days of which only three had event code occurrences),

The “sem” feature is an unbiased standard error of the series S (e.g., does not consider days without event codes). The “var-byserie-biased” feature is a biased variance of S, and the “std-byserie-biased” feature is a biased standard deviation of S (e.g., the square root of “var-byserie-biased”). The “var-byserie-unbiased” feature is an unbiased variance of S, the “std-byserie-unbiased” feature is an unbiased standard deviation of S (e.g., the square root of “var-byserie-unbiased”).

The “quantiles” feature includes the creation of a plurality of intervals (e.g., 21 intervals) within S. For instance, a quantile is each of a set of values of a variate that divide a frequency distribution into equal groups, each containing the same fraction of the total population. This compilation of features can be used to estimate a probability of density of values of S. While the aforementioned statistical features are described herein, other statistical features may be determined in some examples.

Instructions 132, when executed by a processor such as processor 129, can include instructions to classify a status of the particular component using a classifier resulting from a machine learning mechanism applied to the plurality of statistical features. That status includes a classification resulting from a classifier generated by the machine learning mechanism. For instance, the machine learning mechanism can use the generated statistical features to create a classifier that classifies whether the particular component failed or did not fail. While one machine learning mechanism is described herein, more than one machine learning mechanism may be used. For instance, a GBoost machine learning mechanism, an ExtraTrees machine learning mechanism, and a Random Forest machine learning mechanism may be used, among others, alone or in combination, to create the classifier. For instance, in example where the particular component is a fuser, the classifier may result in two classes, “fuser” and “other”. The “fuser” class includes predictions of fuser failure, while the “other” class includes predictions of no failure of the fuser. The classes can be used to predict whether or not a failure of the printing device will be due to a failure of a particular component (e.g., the fuser in this example).

Instructions 133, when executed by a processor such as processor 129, can include instructions to perform an action associated with the particular component based on the classified status. The classified status, for instance, can include one of the “fuser” (e.g., “fail”) or “other” (e.g., “no fail”) classes. For instance, the action can include determining a probability that the particular component caused or will cause a failure of the printing device. Accuracies and precisions, as will be discussed further herein, can be used to determine the probability. Based on results of the classification and the associated probability, it may be determined that the particular component caused the printing device failure (e.g., a “fuser” or “fail” class) or did not cause the printing device failure (e.g., an “other” or “no fail” class).

In some instances, the action can include providing a recommendation with respect to whether the particular component caused a failure of the printing device. For instance, if it is determined that the particular component likely caused the failure or will cause a failure, a recommendation can be made that a technician bring the appropriate replacement components and tools for the next intervention. The recommendation, for instance, can come in the form of an alert to an administrator or directly to the technician in some examples,

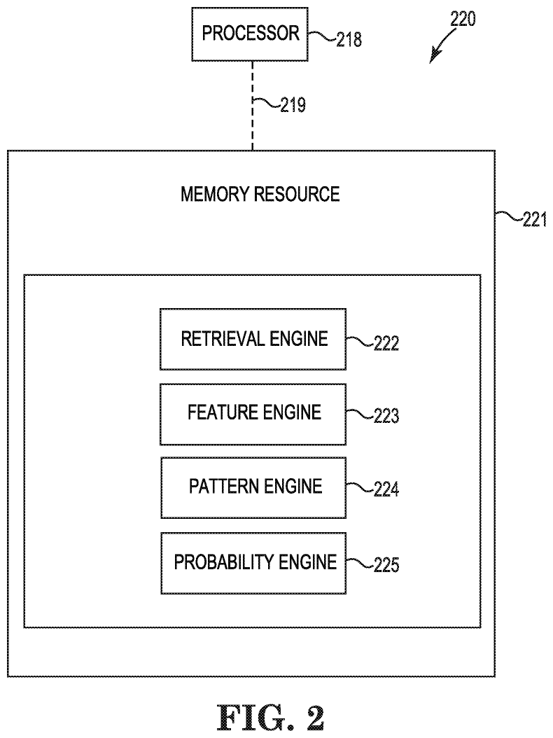

FIG. 2 illustrates a diagram of a controller 220 including a processor 218, a memory resource 221, and engines 222, 223, 224, and 225 according to an example. For instance, the controller 220 can be a combination of hardware and instructions for vulnerability state report creation. The hardware, for example can include a processor 218 and/or a memory resource 221 (e.g., MRM, computer-readable medium (CRM), data store, etc.).

The processor 218, as used herein, can include a number of processing resources capable of executing instructions stored by a memory resource 221. The instructions (e.g., machine-readable instructions (MRI)) can include instructions stored on the memory resource 221 and executable by the processor 218 to implement a desired function (e.g., printing device component status classification). The memory resource 221, as used herein, can include a number of memory components capable of storing non-transitory instructions that can be executed by processor 218. Memory resource 221 can be integrated in a single device or distributed across multiple devices. Further, memory resource 221 can be fully or partially integrated in the same device as processor 218 or it can be separate but accessible to that device and processor 218. Thus, it is noted that the controller 220 can be implemented on an electronic device and/or a collection of electronic devices, among other possibilities.

The memory resource 221 can be in communication with the processor 218 via a communication link (e.g., path) 219. The communication link 219 can be local or remote to an electronic device associated with the processor 218. The memory resource 221 includes engines (e.g., retrieval engine engine 222, feature engine 223, pattern engine 224, and probability engine 225). The memory resource 221 can include more engines than illustrated to perform the various functions described herein.

The engines 222, 223, 224, and 225 can include a combination of hardware and instructions to perform a number of functions described herein (e.g., creating a vulnerability state report). The instructions (e.g., software, firmware, etc.) can be downloaded and stored in a memory resource (e.g., MRM) as well as a hard-wired program (e.g., logic), among other possibilities.

Retrieval engine 222 can retrieve event log data associated with an event code between a last intervention of the printing device and the failure of the printing device. The retrieval can be responsive to a failure of a printing device, in some examples, and the event code can be associated with a particular component of the printing device. For instance, a plurality of event data logs can be retrieved from the printing device, with each event data log having information about events (e.g., type of event, description, date and time, severity, intervention information, etc.). The information can also include event codes associated with particular components of the printing device. For instance, a first event code may be associated with a fuser, while a second event code may be associated with a roller. Event data logs include information about events associated with these components, in some examples. Events can include, for instance, printing device or printing device component failures, printing problems (e.g., jammed paper, out-of-paper), and printing material (e.g., toner, ink, etc.) issues, among others.

Feature engine 223 can generate a plurality of statistical features corresponding to the event code using the retrieved event log data. For instance, generating the statistical features can include calculating mean, mode, quantile, variance, and standard deviation values, among others, of grouped variables of the event log data. The event code, which can include a plurality of octets (e.g., a particular format of code) can be translated into statistical features, as mentioned above, using the grouped variables also known as the series S. For instance, S can include how often the event code happened between the last intervention and a failure of the printing device. This can include the days it happened and the number of times each day it occurred. In some instances, a plurality of event codes is used. Each one of the plurality of event codes has a plurality of statistical features associated with it. The statistical features, as discussed with respect to FIG. 1, can include, for instance, “has”, “sum”, “mean-bydate”, “var-bydate-biased”, “std-bydate-biased”, “mean-byserie”, “sem”, “var-byserie-biased”, “std-byserie-biased”, “var-byserie-unbiased”, “std-byserie-unbiased”, and “quantiles”, among others.

Pattern engine 224 can create a pattern of failure of the particular component of the printing device based on the plurality of statistical features using a classifier resulting from a machine learning mechanism applied to the plurality of statistical features. For instance, the plurality of statistical features can describe a life behavior of a printing device, which can lead to a creation of patterns of printer component failure. Using a machine learning mechanism (or a plurality of machine learning mechanisms), the plurality of statistical features can be classified as “fail” (e.g., “fuser” class as discussed with respect to FIG. 1) or “not fail” (e.g., “other” class as discussed with respect to FIG. 1). For instance, in response to a printing device failing, the statistical features and machine learning mechanisms may reveal the printing device failed each time a fuser failed. Based on this, a pattern of failure of a fuser failure followed by a printing device failure can be determined. Similar, in response to a printing device failing, the statistical features and machine learning mechanisms may reveal that each time (or some of the times) the printing device failed, the fuser did not fail, but a roller did. Based on this, a pattern of failure of a printing device failure preceded by a roller failure may be determined.

Based on the pattern of failure, it can be determined whether an intervention is needed or will be needed in the future and what a probable cause of a printing device failure is. This can prepare a technician for repair of the printing device. For instance, probability engine 225 can determine a probability that the particular component caused the failure of the printing device based on the pattern of failure. As noted, based on the pattern of failure, it may be determined that a particular component of the printing device (e.g., a fuser of a multifunctional printer) caused the failure or didn't cause the failure. If the pattern points to the particular component being the cause of the failure, a technician can come to the intervention with a replacement fuser, saving the technician and user time and money.

In some instances, with respect to probability, an accuracy and precision associated with the particular component causing the failure of the printing device can be determined (e.g., during the probability determination). Table 1 illustrates example different values of accuracy, precision, and overall recall in “Fuser” and “Other” classes. The recall of a class is the ratio between the numbers of true positives generated by the classifier and the number of elements of the class under study. An overall recall is the weighted mean between the class recalls using the number of elements of each class as weights.

TABLE 1

| | Fuser | Other | Fuser | Other | Overall |
|---|---|---|---|---|---|
| | Accuracy | Accuracy | Precision | Precision | Recall |
| G Boost | 84% | 79% | 34% | 97% | 73% |
| ExtraTrees | 86% | 78% | 34% | 98% | 71% |
| Random | 85% | 74% | 30% | 97% | 66% |
| Forest | | | | | |

In the example in Table 1, two measurements, accuracy and precision, of how each classifier (e.g., GBoost, ExtraTrees, Random Forest) performed are displayed. Fuser accuracy refers to how often fuser interventions (e.g., fuser failed) are classified correctly. For instance, GBoost at 84 percent suggests that 84 percent of the time a classification is made regarding a fuser intervention, the classification is correct.

Fuser precision refers to a confidence level in the classification of a failed fuser. A higher precision implies fewer false positive predictions. For instance, in an example where 50 percent of the failures are actually caused by the fuser and 50 percent are caused by a different component (e.g., “other” component), if a classifier always says the fuser failed, the accuracy is 100 percent because in all the times the printing device failed, the fuser failed. However, in this instance, the precision would be 50 percent because 50 percent of the time the printing device failed, the fuser didn't actually cause the failure of the printing device; rather it was caused by a different component or user error.

The values of precision, accuracy, and recall may depend on the printing device, printing components, and the machine learning mechanism used. Depending on these, confidence levels in the results may be determined and may vary. For instance, in the example illustrated in Table 2, a confidence level may be high that the fuser did not fail and that a technician need not bring a fuser when the printing device is due for repair.

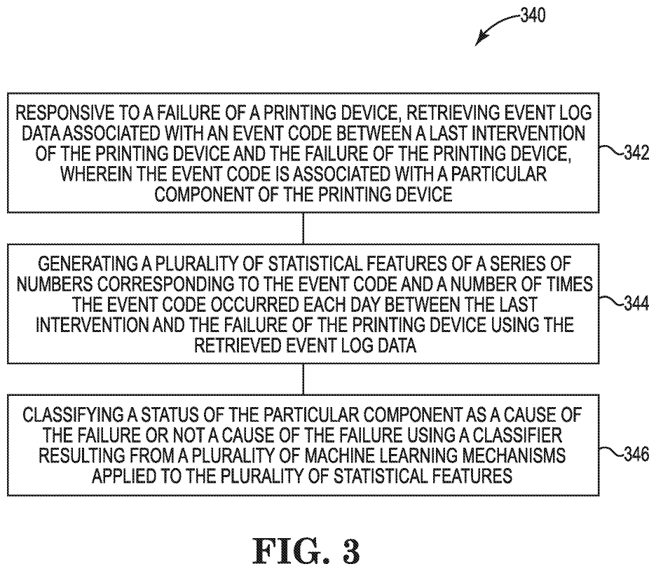

FIG. 3 illustrates a method 340 for printing device component status classification according to an example. Method 340 may be performed by a system 128 and/or controller 220 as described with respect to FIGS. 1 and 2. In some instances, system 128 and/or controller 220 may be located on the printing device,

At 342, method 340 includes retrieving event log data associated with an event code between a last intervention of the printing device and the failure of the printing device. In some examples, the retrieval is responsive to a failure of a printing device, and the event code is associated with a particular component of the printing device. For instance, an event code may be associated with a fuser of a multifunctional printing device. Additionally or alternatively, event codes associated with different components of the printing device may be part of the event log data. The retrieved data, in some instances, includes descriptive information of the event (e.g., severity, data and time of occurrence, event code, etc.), printing device and scanning usage information (e.g., print count, scan count, etc.), and intervention information (e.g., intervention count, interventiondate and time, component replaced, etc.), among others.

At 344, method 340 includes generating a plurality of statistical features of a series of numbers corresponding to the event code and a number of times the event code occurred each day between the last intervention and the failure of the printing device using the retrieved event log data. For instance, statistical features are generated by calculating values of statistical features, allowing for a discovery of a pattern of printing device failures. In particular, for each event code, a series, S including the number of times the event code occurred between the last intervention and a printing device failure (e.g., the number of days and the number of times per day) is built. The statistical features are determined based on S for each event code.

In some examples, the plurality of statistical features includes unbiased and biased statistical features. Unbiased statistical features are statistical features based on a number of days and a number of times per day the event code was present between the last intervention and the failure of the printing device. Biased statistical features are statistical features based on a number of days and a number of times per day between the last intervention and the failure of the printing device regardless of whether the event code was present on each of the number of days. For instance, as discussed with reference to FIG. 1, a “var-byserie-biased” statistical feature is a variance of S considering days an event occurred between the last intervention and a printing device failure, but not days the event did not occur. In contrast, a “var-byserie-unbiased” statistical feature is a variance of S considering all days between the last intervention and the printing device failure, regardless of whether the event did or did not occur.

At 346, method 340 includes classifying a status of the particular component as a cause of the failure or not a cause of the failure using a classifier resulting from a plurality of machine learning mechanisms applied to the plurality of statistical features. For instance, the status can include machine learning mechanism created classes such as “fail” or “not fail” that classify a particular component as the cause of the failure of the printing device or not the cause of the failure of the printing device. In some instances, a confidence level can be provided to the status of the particular component based on a result of the status classification. This confidence level, for instance, can be dependent on an accuracy and precision of each one of the plurality of machine learning mechanisms, as described with respect to FIG. 2 and Table 1.

Classifications can be made in real time once a machine learning classifier is completed. For instance, once the statistical features are fed into the machine learning mechanism and the classifier is determined, classifications of particular printer components can be made in real time as “fail” or “no fail”, for instance. The classifier may be updated and/or adjusted as desired, for instance, in response to false-positive classifications being above a particular threshold, among other reasons.

By classifying a particular component, a status of the particular component can be determined remotely such that a technician can be alerted which part of the printing device has or may fail (e.g., is defective). As a result, when the technician goes to the location of the printing device, the technician may already know what component to change, reducing time that the printing device is out of operation, reducing costs, reducing technician time administration, and improving inventory management. The printing device performance can improve, for instance when a component predicted to cause failure of the printing device is replaced before failure occurs (e.g., at a periodic, scheduled intervention),

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature may refer to one or more of such elements and/or features.

What is claimed is:

1. A non-transitory machine-readable medium containing instructions executable by a processor to cause the processor to:
generate a plurality of statistical features corresponding to an event code associated with a particular component of a printing device using retrieved event log data of the printing device;
classify a status of the particular component using a classifier resulting from a machine learning mechanism applied to the plurality of statistical features; and
perform an action associated with the particular component based on the classified status.

2. The medium of claim 1, wherein the instructions executable to perform the action comprise instructions executable to determine a probability that the particular component caused a failure of the printing device.

3. The medium of claim 1, wherein the instructions executable to perform the action comprise instructions executable to provide a recommendation whether the particular component caused a failure of the printing device.

4. The medium of claim 1, wherein the retrieved event log data comprises event log data between a previous printing device intervention and a day the printing device failed.

5. The medium of claim 1, further comprising instructions executable to create for the event code a series of a number of times the event code occurred in a particular time period.

6. The medium of claim 1, wherein the event code comprises a plurality of octets that represent a plurality of printing device components including the particular component and provide information related to each one of the plurality of components.

7. The medium of claim 1, wherein the event code comprises a plurality of octets that represent an instruction received by the printing device and associated with a plurality of printing device components including the particular component that happened during a failure of the printing device.

8. A controller comprising a processor in communication with a memory resource including instructions executable to:
responsive to a failure of a printing device, retrieve event log data associated with an event code between a last intervention of the printing device and the failure of the printing device, wherein the event code is associated with a particular component of the printing device;
generate a plurality of statistical features corresponding to the event code using the retrieved event log data;
create a pattern of failure of the particular component of the printing device based on the plurality of statistical features using a classifier resulting from a machine learning mechanism applied to the plurality of statistical features; and
determine a probability that the particular component caused the failure of the printing device based on the pattern of failure.

9. The controller of claim 8, further comprising the instructions executable to generate the plurality of statistical features by calculating mean, mode, quantile, variance, and standard deviation values of grouped variables of the event log data.

10. The controller of claim 8, wherein the instructions executable to determine the probability further comprise instructions executable to determine an accuracy and precision associated with the particular component causing the failure of the printing device.

11. The controller of claim 8, wherein the printing device is a multifunctional printing device and the particular component is a fuser.

12. A method, comprising:
responsive to a failure of a printing device, retrieving event log data associated with an event code between a last intervention of the printing device and the failure of the printing device, wherein the event code is associated with a particular component of the printing device;
generating a plurality of statistical features of a series of numbers corresponding to the event code and a number of times the event code occurred each day between the last intervention and the failure of the printing device using the retrieved event log data; and
classifying a status of the particular component as a cause of the failure or not a cause of the failure using a classifier resulting from a plurality of machine learning mechanisms applied to the plurality of statistical features.

13. The method of claim 12, further comprising providing a confidence level to the status of the particular component based on a result of the status classification.

14. The method of claim 2, wherein generating the plurality of statistical features comprises generating:
a plurality of unbiased statistical features, wherein unbiased statistical features are based on a number of days and a number of times per day the event code was present between the last intervention and the failure of the printing device; and
a plurality of biased statistical features, wherein biased statistical features are based on a number of days and a number of times per day between the last intervention and the failure of the printing device regardless of whether the event code was present on each of the number of days.

15. The method of claim 12, wherein retrieving event log data comprises retrieving data associated with an event including descriptive information of the event, printing device usage information, scanning, and intervention information.
